(19) United States
(12) Patent Application Publication
(10) Pub. No.: US 2020/0023720 A1
(43) Pub. Date: Jan. 23, 2020

(54) VEHICLE ACTUATOR CABLE DAMPENER

(71) Applicant: Brose Fahrzeugteile GmbH & Co. KG, Bamberg (DE)

(72) Inventors: Erik SCHUETT, Rochster Hills, MI (US); John FLECK, Holly, MI (US); Chase REAMES, Rochester Hills, MI (US)

(21) Appl. No.: 16/037,371

(22) Filed: Jul. 17, 2018

(51) Int. Cl. B60J 5/04; E05B 79/20

(52) U.S. Cl. CPC B60J 5/0418; B60R 16/0215; E05B 79/20

(57) ABSTRACT

A vehicle actuator cable assembly is provided. The cable assembly may include a rail, a pulley, a cable, and a dampener sleeve. The rail may be attachable to a vehicle panel and the pulley may be rotatably coupled to the rail. The cable may include a wire that is movable by the pulley and a cover that partially surrounds a portion of the wire. The dampener sleeve may define an outer wall and an inner wall that surrounds a portion of the cover. The inner wall may define protrusions that inwardly extend from the inner wall so that the protrusions engage a portion of the cover.

### TECHNICAL FIELD

The present disclosure relates to cable assemblies for automotive vehicles, and more specifically, dampeners for cable assemblies used to improve acoustic performance of doors and seat assemblies.

### BACKGROUND

Vehicle doors, windows, hatches, panels, and the like are often secured or moved by one or more mechanical or electro-mechanical mechanisms. These mechanical or electro-mechanical mechanisms may be actuated or powered by one or more cables stretching from the mechanism to an actuator within the vehicle. These cables may be disposed within a cavity or aperture formed by one or more vehicle body panels or other structural members.

The cables often include a protective cover, normally comprised of a relatively hard plastic material. As the cable vibrates or moves side to side, the protective cover may contact an adjacent vehicle body panel or structural member causing a noise or vibrations. Plastic or polymeric sleeves may cover portions of the cable to inhibit or lessen the noise or vibration between the cover of the cable and the vehicle.

### SUMMARY

According to one embodiment of this disclosure, a vehicle actuator cable assembly is provided. The cable assembly may include a rail, a pulley, a cable, and a dampener sleeve. The rail may be attachable to a vehicle panel and the pulley may be rotatably coupled to the rail. The cable may include a wire that is movable by the pulley and a cover that partially surrounds a portion of the wire. The dampener sleeve may define an outer wall and an inner wall that surrounds a portion of the cover. The inner wall may define protrusions that inwardly extend from the inner wall so that the protrusions engage a portion of the cover.

According to another embodiment of this disclosure, a vehicle door panel assembly is provided. The door panel assembly may include an inner door panel that is attachable to an outer door panel, a cable, and a dampener sleeve. The cable may extend across at a least a portion of the inner door panel and be operatively connected to an actuator and a mechanism. The dampener sleeve may be disposed on the cable and include protrusions that inwardly extend from an inner wall of the sleeve.

According to yet another embodiment of this disclosure, a dampener sleeve for use with a vehicle actuator assembly that includes a cable assembly that may be operatively coupled to an actuator and a mechanism. The dampener sleeve may be comprised of an elongated body that defines an inner wall and an outer wall. The inner wall may include protrusions that receive and engage portions of the cable assembly when the cable assembly is inserted into the dampener sleeve.

### BRIEF DESCRIPTION OF THE DRAWINGS

FIG. 1 is an environmental-perspective view of an exemplary vehicle that includes a window regulator assembly.

FIG. 2 is a plan view of the window regulator assembly shown in FIG. 1.

FIG. 2A is a cross-sectional view taken along the lines 3-A in FIG. 2 of an exemplary prior-art sleeve.

FIG. 2B is a cross-sectional view taken along the lines 3-A in FIG. 2 of the exemplary prior-art sleeve in FIG. 2A after shrinking.

FIG. 3 is a plan view of another exemplary window regulator assembly.

FIG. 3A is a cross-sectional view taken along the lines 3-A in FIG. 2 of a dampener sleeve according to at least on embodiment.

FIG. 4 is a plan view of an exemplary door module that includes a dampener sleeve according to at least one embodiment.

FIG. 4A is a detailed view of a portion of the door module in FIG. 4.

FIG. 5 is a perspective view of a dampener sleeve according to a second embodiment of this disclosure.

FIG. 5A is a cross-sectional view of the dampener sleeve in FIG. 5.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Actuation of mechanisms such as latches, windows carriers or regulators, door drives, etc. are generally connected by a wire or a cable to a source of power, mechanical actuator, electrical-mechanical actuator, or some combination thereof. These cables and wires are often hidden between two or more vehicle panels so that they out of vehicle occupant's eyesight. The cables and wires, stretching across portions of the panels, may move or vibrate and contact the panels, which has the potential to create an audible sound or noise within the vehicle cabin. The loudness or harshness of the noise may be caused by the relatively hard protective cover of the cable or wire contacting a relatively hard vehicle panel.

Covers or sleeves comprised of a softer material such as foam or rubber have been used to prevent this noise. However, for many different reasons, the inner diameter of the sleeve may increase or fluctuate over time. If the inner diameter of the sleeve increases too much, a gap may form between the cable or wire and the inner wall of the sleeve. This gap allows for relative movement between the cable or wire and the sleeve and may create another audible sound or noise within the vehicle cabin. This disclosure provides solutions to these problems.

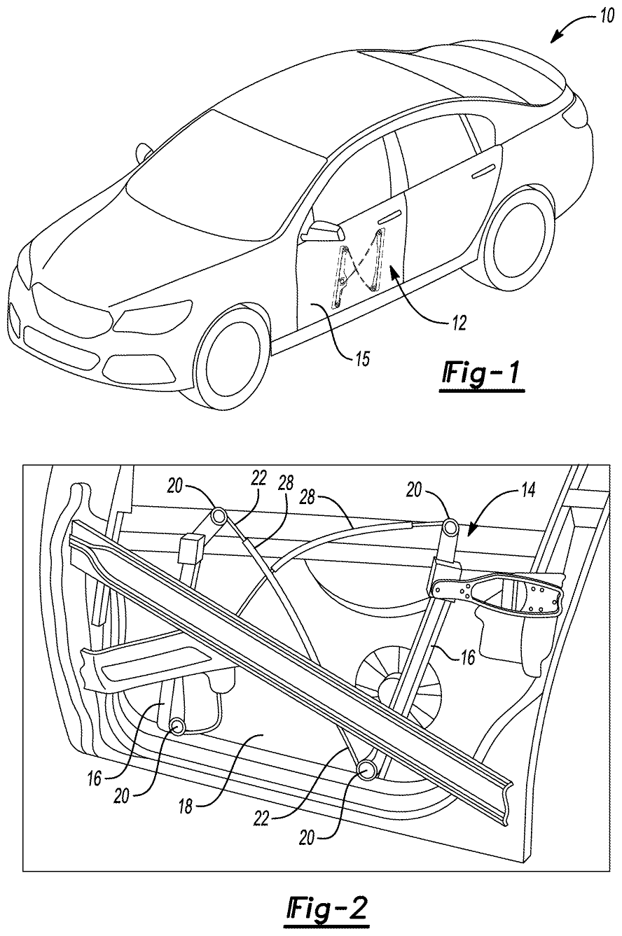

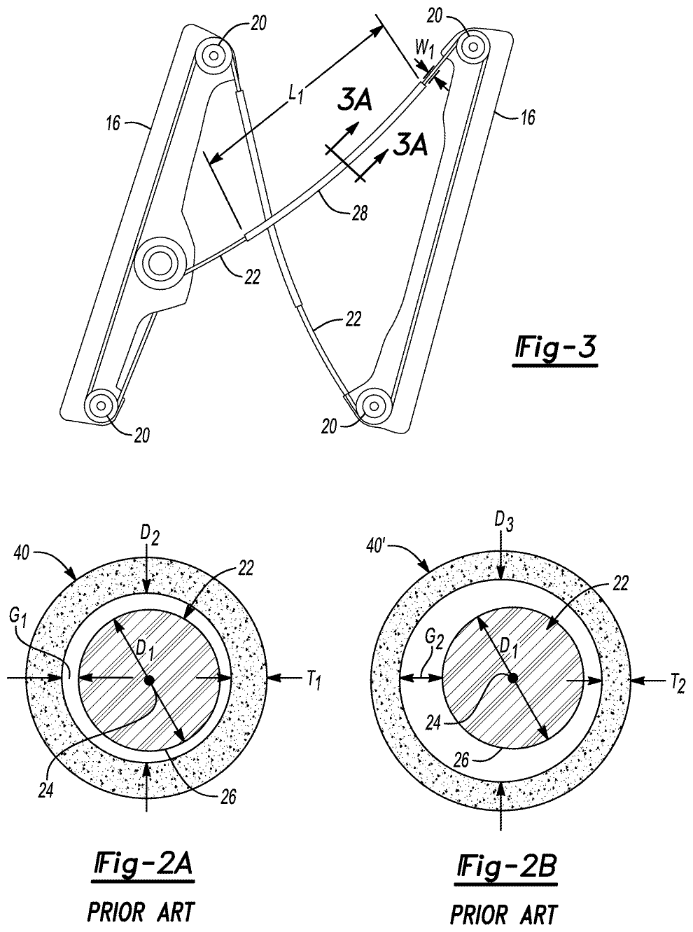

FIGS. 1-3 show a vehicle 10 that includes a door 12, and a vehicle actuator cable assembly, such as a window regulator assembly 14. The vehicle door 12 may include an outer panel 15 and an inner panel 18. The window regulator assembly 14 may raise and lower a pane of glass 19 within the door 12. The window regulator assembly 14 illustrated in FIG. 1 and FIG. 2 is just one example of a window regulator assembly.

The window regulator assembly 14 may include one or more rails 16 that are attachable to one of the panels, such as the inner panel 18 shown. The window regulator assembly 14 may include one or more pulleys 20 that are rotatably coupled to the rails. The window regulator assembly 14 may also include a cable 22 comprised of a wire 24, that is movable by the pulleys 20, and a cover 26 that partially surrounds a portion of the wire 24.

The window regulator assembly 14 includes a sleeve, such as a dampener sleeve 28 that may be carried by the cable 22. The dampener sleeve 28 may prevent portions of the cover 26 from contacting the outer panel 15, or inner panel 18, or the pane of glass 19. If the cable 22 moves and the cover 26 contacts the panels, a noise may occur. The noise may be relatively distinct because of the hardness of the cover and the hardness of the inner panels, outer panels, and glass. This noise may be a disturbance or annoyance to users of the vehicle. The dampener sleeve 28 includes an outer wall 30 and an inner wall 32 that surrounds a portion of the cover 26. The inner wall 32 defines one or more protrusions 34 that extend radially from the inner wall 32 to engage a portion of the cover 26 of the cable 22. Because the one or more protrusions engage the cable 22 relative movement between the inner wall 32 and the cable is mitigated or prevented altogether.

The dampener sleeve 28 may have an elongated shape, in other words, the length L₁ of the sleeve is greater than the width W₁ of the sleeve. The number of protrusions 34 defined by the inner wall 32 may vary. But at least three protrusions 34, arranged in a triangular configuration, are required so that relative-radial movement between the cable 22 and the inner wall is mitigated or prevented. The dampener sleeve 28 may be comprised of a semi-rigid material, such as a thermoplastic elastomer closed-cell foam such as polyurethane or polyolefin. Semi-rigid means a material that is structurally sufficient to support itself and not collapse under zero or minimal load.

Referring specifically to FIGS. 2A and 2B, a cross-sectional view of a prior-art dampener sleeve 40 surrounding the cable 22 is illustrated. The cover 26 of each of the cables 22 defines an outer diameter of D₁. FIG. 2A depicts a sleeve 40 defining an inner diameter D₂ that surrounds the cable 22 and forms a clearance G₁ between the sleeve 40 and the cover 26. This clearance G₁ does not allow much, if any, relative movement between the cable 22 and the inner wall 32. Whereas, in FIG. 2B the clearance G₂ between the sleeve 40′ and the cover 26 of the cable 22 is significantly larger. This larger clearance G₂ allows the cable 22 to move relative to the sleeve and may result in the noise mentioned above.

The larger clearance G₂ is due to shrinking of the sleeve material, thus decreasing the thickness of the wall from thickness T₁ to T₂ and increasing the inner diameter D₃ of the sleeve 40′. The shrinking wall thickness may be due to one of several environmental conditions, such as moisture caused by precipitation or condensation on the sleeve or a change in temperature over a relatively short period of time, in combination with the shrink rate of the foam material. Shrink rate is a rate of change of a material's dimensions over time. As one example, the polyurethane closed-cell foam may have a shrink rate ranging between 5% and 15%. The term shrink rate may also be known as shrinkage. Shrinkage may refer to a dimensional (e.g., thickness, length, width) decrease over time. Moreover, shrinkage may be measured by one or more standardized tests, such as ASTM D212609.

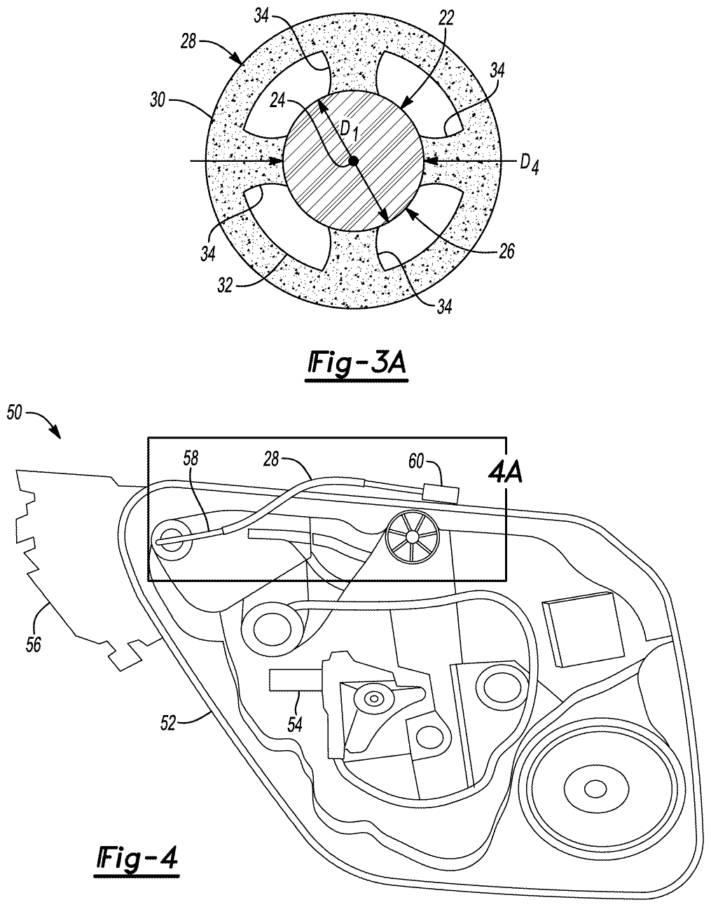

One way to resolve this loose condition is to increase the wall thickness T₁ to account for or compensate for the shrink rate of the material. Increasing the wall thickness T₁ results in decreasing the inner diameter D₃. While decreasing the inner diameter D₃ may prevent the condition shown in FIG. 2B, it may also increase the force, or insertion force, required to assemble the sleeve 40 to the cable 22. Increased insertion forces may lead to an increase in time required for assembly and cause a decrease in production efficiency. Another possible solution to the loose condition is the dampener sleeve 28 shown in FIG. 3. The dampener sleeve 28 in FIG. 3, includes protrusions 34 that extend inwardly from the inner wall 32. While four protrusions are illustrated, in other embodiments more or less protrusions may be used. The protrusions 34 may deflect or deform towards the inner wall 32 as the cable 22 is inserted into the sleeve 28. While this configuration may increase the insertion forces required for assembly, the deflection of the protrusions 34 may minimize the increase in insertion forces.

In one embodiment, the protrusions may extend along the entire length of the sleeve. Because the protrusions 34 extend along the length of the sleeve 38, the protrusions may maintain constant contact where the cable 22, even as the inner diameter of the sleeve 28 constricts or expands. Moreover, the insertion force required for assembling the cable is constant because of the uniform inner diameter defined by the protrusions 34.

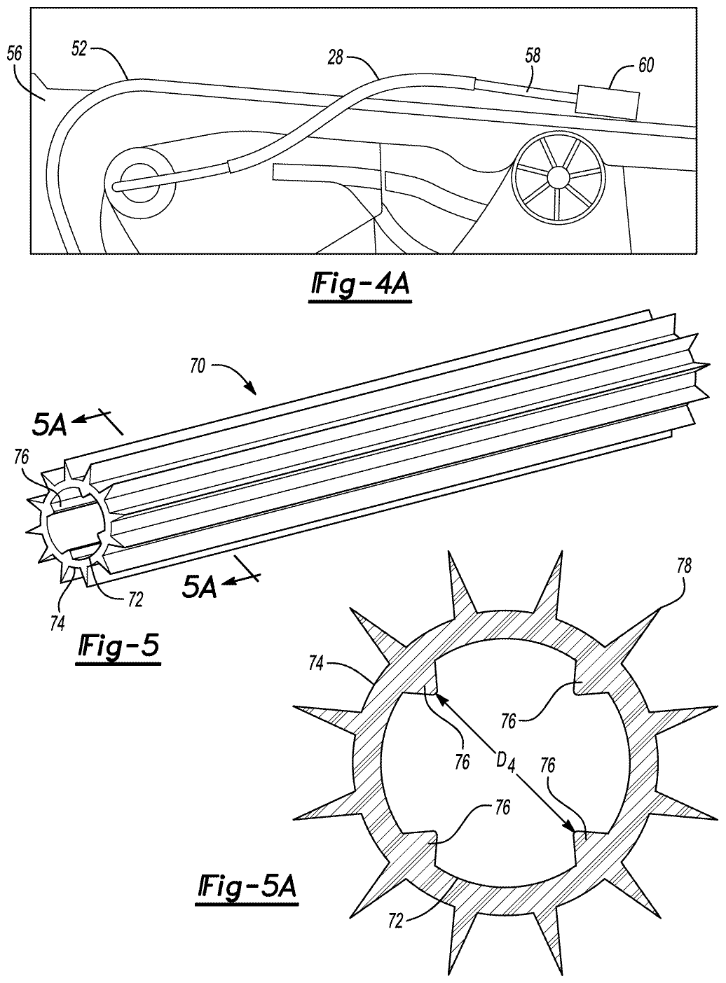

In another embodiment, the dampener sleeve 28 may be assembled to a door module assembly 50, as illustrated in FIG. 4. The door module assembly 50 may include a door panel, such as an inner door panel 52, that is attachable to an outer door panel (not illustrated). The door module 50 may include one or more mechanisms, such as a gearbox assembly 54 that moves a cable and window carrier to position a window, or a latch 56 that may engage a portion of the vehicle body to secure the door. Referring to FIG. 4A, a detailed view of a portion of the door module 50 is illustrated. Here the latch 56 is attached to a latch wire 58, that includes a connector 60 that may be connected to an actuator, such as a switch (not illustrated). The dampener sleeve 28 is assembled to the latch wire 56 so that it is positioned between the inner door panel 52 and the latch wire 56. In other embodiments, the dampener sleeve may be assembled to other wires or cables within the door module assembly. The dampener sleeve 28 is identical that illustrated in FIGS. 2 and 3, and its description will not be duplicated.

FIG. 5 and FIG. 5A each show a dampener sleeve 70 according to a second embodiment of this disclosure. The dampener sleeve 70 includes an inner wall 72 and an outer wall 74. The inner wall 72 may include three or more inner protrusions 76 that are configured to cooperate with one another to engage the wires or cables previously described above (not pictured). Two of the protrusions are spaced apart to define a diameter D₄ so that relative movement between the cable or wire is prevented or mitigated. While the protrusions illustrated have a triangular shape, other convex shapes may be suitable.

This dampener sleeve 70 may be comprised of a rubber type of material such as ethyl propylene diene monomer rubber, as opposed to the foam material of the dampener sleeve 28. The dampener sleeve 70 may be adhered to certain portions of the cable, allowing for a shorter dampener sleeve. Adhering the dampener sleeve to the cable maybe accomplished by a glue or adhesive (not illustrated). The dampener sleeve 70 may be fixed to a vehicle panel in a predetermined position by a fastener, such as a clip or a pin (not illustrated). The predetermined position may be selected so that the portions of cable or wire not covered by the dampener sleeve do not contact one of the vehicle panels.

The outer wall 74 may include outer protrusions or external protrusions 78. The external protrusions taper from the outer wall 74 to the distal end. This taper decreases the cross-sectional area of the outer portions of the sleeve with the goal of mitigating or preventing noise created by the glass pane 19 or car door panels 15, 18 moving across the dampener sleeve 70. The dampener sleeve 28 of the first embodiment and the dampener sleeve 70 of the second embodiment may be implemented in various assemblies, such as the window regulator illustrated in FIGS. 1-2 or the door module assembly illustrated in FIGS. 4-4A. Moreover, the dampener sleeves of the first and second embodiments may be used in other vehicle assemblies that are not pictured.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Parts List

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.
vehicle 10
door 12
window regulator assembly 14
outer panel 15
rails 16
inner panel 18
glass 19
pulleys 20
cable 22
wire 24
cover 26
dampener sleeve 28
outer wall 30
inner wall 32
protrusions 34
sleeve 38
prior-art dampener sleeve 40
prior-art dampener sleeve 40′
door module 50
inner door panel 52
gearbox assembly 54
latch 56
latch wire 56
connector 60
dampener sleeve 70
inner wall 72
outer wall 74
inner protrusions 76
external protrusions 78

What is claimed is:

1. A vehicle actuator cable assembly comprising:
a rail attachable to a vehicle panel;
a pulley rotatably coupled to the rail;
a cable including a wire that is movable by the pulley, and a cover at least partially surrounding a portion of the wire; and
a dampener sleeve defining an outer wall, an inner wall surrounding a portion of the cover, wherein the inner wall defines protrusions extending inwardly and engaging a portion of the cover.

2. The vehicle actuator cable assembly of claim 1, wherein the dampener sleeve includes protrusions radially and outwardly extending from the outer wall.

3. The vehicle actuator cable assembly of claim 1, wherein the dampener sleeve is comprised of a closed-cell foam material.

4. The vehicle actuator cable assembly of claim 1, wherein the dampener sleeve has an elongated shape and defines a length and wherein the protrusions extend along the length.

5. The vehicle actuator cable assembly of claim 1, wherein the cover defines an outer diameter wherein each of the protrusions includes a distal end, and wherein the distal ends partially define a diameter that is less than the outer diameter defined by the cover.

6. The vehicle actuator cable assembly of claim 1, wherein the protrusions are spaced apart so that a force associated with inserting the cable into the dampener sleeve is no greater than 100 N.

7. A vehicle door panel assembly comprising:
an inner door panel attachable to an outer door panel;
a cable extending across at least a portion of the inner door panel and operatively connected to an actuator; and
a dampener sleeve disposed around the cable, wherein the dampener sleeve includes protrusions that inwardly extend from an inner wall of the sleeve.

8. The vehicle door panel assembly of claim 7, wherein the dampener sleeve is comprised of a material that has a shrink rate of at least 10%.

9. The vehicle door panel assembly of claim 8, wherein each of the protrusions define a height so that at least three of the protrusions engage portions of the cable regardless of an increase of the inner diameter associated with the shrink rate.

10. The vehicle door panel assembly of claim 9, wherein the protrusions are comprised of a semi-rigid material configured to deflect towards the outer wall of the dampener sleeve.

11. The vehicle door panel assembly of claim 9, wherein the dampener sleeve includes external protrusions radially and outwardly extending from an outer wall of the sleeve.

12. The vehicle door panel assembly of claim 11, wherein the protrusions are adhered to the cable.

13. The vehicle door panel assembly of claim 12, wherein the dampener sleeve is comprised of a rubber material.

14. A dampener sleeve for use with a vehicle actuator assembly that includes a cable assembly that is operatively coupled to an actuator and a mechanism, the dampener sleeve comprising:
an elongated body that defines an inner wall and an outer wall, wherein the inner wall includes protrusions that receive and engage portions of the cable assembly when the cable assembly is inserted into the dampener sleeve.

15. The dampener sleeve of claim 14, wherein the inner wall defines three protrusions arranged to define a triangular shape.

16. The dampener sleeve of claim 14, wherein the protrusions are comprised of a semi-rigid material configured to deflect towards the outer wall of the dampener sleeve.

17. The dampener sleeve of claim 14, wherein the dampener sleeve includes protrusions radially and outwardly extending form the outer wall.

18. The dampener sleeve of claim 17, wherein each of the protrusions includes a distal pointed end.

19. The dampener sleeve of claim 14, wherein the protrusions are spaced apart so that a force associated with inserting the cable into the dampener sleeve is no greater than 100 N.

20. The dampener sleeve of claim 19, wherein at least one of the protrusions has a convex shape.
